(19) United States
(12) Patent Application Publication
(10) Pub. No.: US 2026/0219119 A1
(43) Pub. Date: Jul. 30, 2026

(54) ABNORMALITY DETECTING DEVICE

(71) Applicant: KABUSHIKI KAISHA TOKAI RIKA DENKI SEISAKUSHO, Aichi (JP)

(72) Inventors: Masanori KOSUGI, Aichi (JP); Yasuhiro SHIBATA, Aichi (JP)

(73) Assignee: KABUSHIKI KAISHA TOKAI RIKA DENKI SEISAKUSHO, Aichi (JP)

(21) Appl. No.: 19/151,673

(22) PCT Filed: Mar. 15, 2024
(86) PCT No.: PCT/JP2024/010189

§ 371 Date: Jul. 29, 2025

(30) Foreign Application Priority Data
Mar. 31, 2023 (JP) 2023-057868

(51) Int. Cl. G01L 5/24

(52) U.S. Cl. CPC G01L 5/24

(57) ABSTRACT

An abnormality detecting device is adapted to be attached to a nut for fixing a wheel to a vehicle. A sensor is configured to output a detection signal corresponding to a fastening state of the nut to a bolt. A processor is configured to detect an abnormality in the fastening state based on the detection signal. An indicator is configured to perform a visual notification of the abnormality. The processor is configured to cause the indicator to start the visual notification in a case where the abnormality is detected under a condition that a stationary state of the wheel is detected.

### FIELD

The presently disclosed subject matter relates to an abnormality detecting device adapted to be attached to a fastening member for fixing a wheel to a vehicle.

### BACKGROUND

Japanese Patent Publication No. 2005-329907 A discloses a device for detecting a state that a wheel is abnormally fixed to a vehicle based on a signal outputted from an acceleration sensor attached to the wheel.

### SUMMARY OF THE INVENTION

### Technical Problem

It is demanded to improve convenience of a device for detecting a state that a wheel is abnormally fixed to a vehicle.

### Solution to Problem

An illustrative aspect of the presently disclosed subject matter may provide an abnormality detecting device adapted to be attached to a fastening member for fixing a wheel to a vehicle, comprising:
a sensor configured to output a detection signal corresponding to a fastening state of the fastening member;
a processor configured to detect an abnormality in the fastening state based on the detection signal; and
an indicator configured to perform a visual notification of the abnormality,
wherein the processor is configured to cause the indicator to start the visual notification in a case where the abnormality is detected under a condition that a stationary state of the wheel is detected.

According to the configuration described above, it is possible to improve the flexibility as for selection of how to perform the visual notification. For example, a notification with red or orange light emission is preferable because a high level of alert to the abnormality can be provided. However, in a case where such a notification is performed by the indicator of the abnormality detecting device attached to the fastening member while the vehicle is traveling, misunderstanding or confusion would be occurred in another traffic entity (another vehicle, a pedestrian, or the like). According to the above configuration, since the notification is performed only during the stoppage of the vehicle, it is possible to actively utilize such a way of notification that can provide the high level of alert to the abnormality while suppressing the possible influence on another traffic entity. Accordingly, it is possible to improve the convenience of the device for detecting the state that the wheel is abnormally fixed to the vehicle.

### BRIEF DESCRIPTION OF DRAWINGS

FIG. 1 illustrates a vehicle in which an abnormality detecting device according to one embodiment is to be installed.

FIG. 2 illustrates a nut to which the abnormality detecting device is to be attached.

FIG. 3 illustrates an appearance of the abnormality detecting device.

FIG. 4 illustrates a functional configuration of the abnormality detecting device.

FIG. 5 is a diagram for explaining a function of the sensor in FIG. 4.

FIG. 6 illustrates an exemplary flow of processing to be executed by the processor in FIG. 4.

FIG. 7 illustrates another exemplary flow of processing to be executed by the processor in FIG. 4.

FIG. 8 illustrates another exemplary flow of processing to be executed by the processor in FIG. 4.

### DESCRIPTION OF EMBODIMENTS

Exemplary embodiments will be described in detail below with reference to the accompanying drawings. In each of the drawings, the scale is appropriately changed in order to make each element as illustrated have a recognizable size.

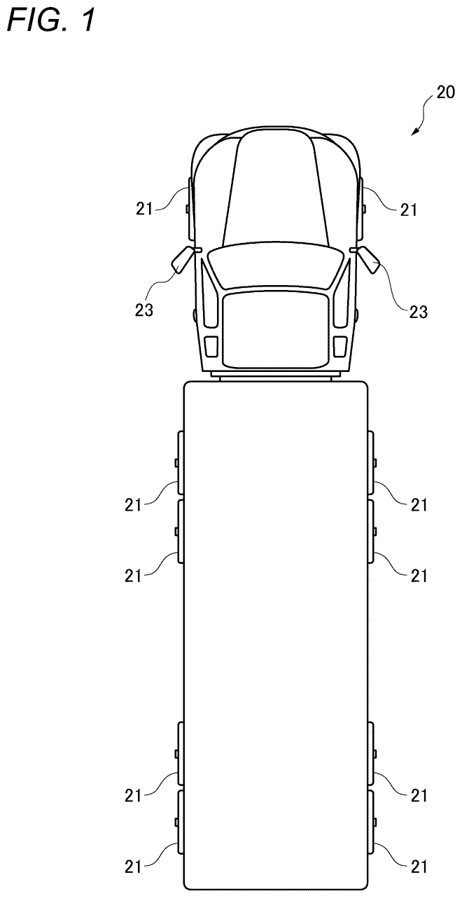

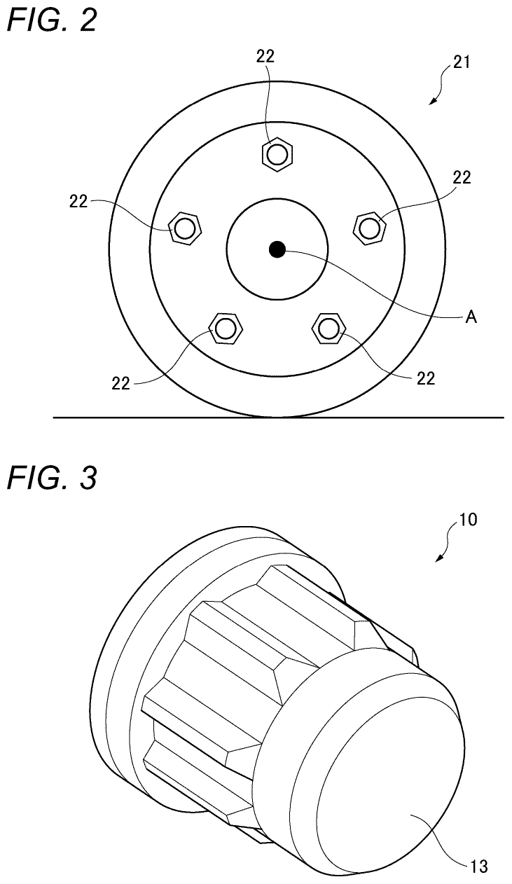

FIG. 1 illustrates a vehicle 20 equipped with an abnormality detecting device according to an embodiment. The vehicle 20 includes multiple wheels 21. As illustrated in FIG. 2, the vehicle 20 includes multiple nuts 22. Each nut 22 is fastened to a bolt for fixing the wheel 21 to the vehicle 20. Each of the bolt and the nut is an example of a fastening member.

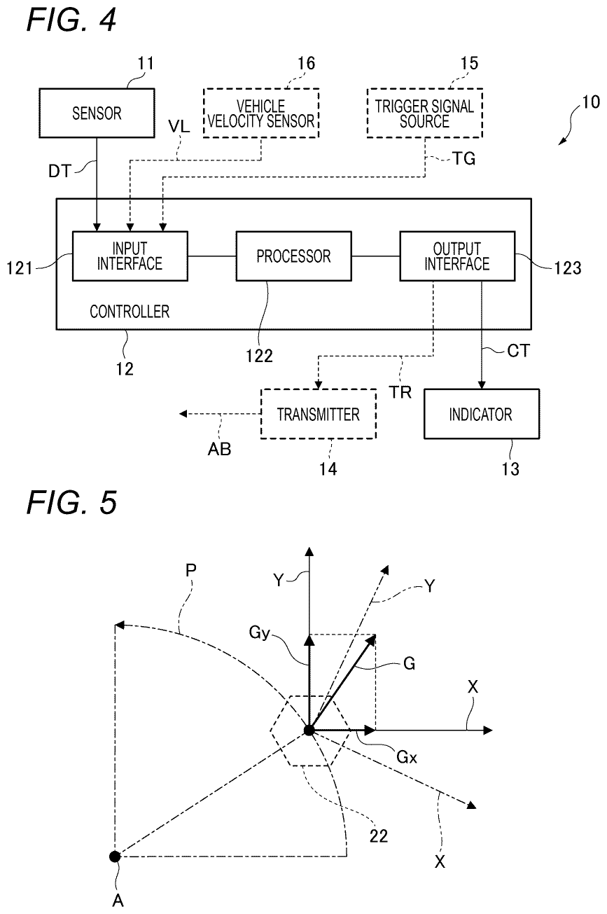

FIG. 3 illustrates an appearance of the abnormality detecting device 10. The abnormality detecting device 10 is configured to be attached to each nut 22. FIG. 4 illustrates a functional configuration of the abnormality detecting device 10.

The abnormality detecting device 10 includes a sensor 11. The sensor 11 is configured to output a detection signal DT corresponding to a fastening state of the nut 22 with respect to the bolt.

As an example, the sensor 11 may be an acceleration sensor. As illustrated in FIG. 5, supposing a case where an X-axis and a Y-axis extending perpendicularly are defined in a plane spreading orthogonally to a rotation axis A of the wheel 21, the acceleration sensor is configured to detect an acceleration Gx in a direction along the X-axis and an acceleration Gy in a direction along the Y-axis. In other words, the acceleration sensor is configured to output the detection signal DT including information corresponding to the acceleration Gx and information corresponding to the acceleration Gy. The detection signal DT may be an analog signal or a digital signal in accordance with the specification of the acceleration sensor.

In this example, the X axis extends in the horizontal direction, and the Y axis extends in the vertical direction. However, as long as they are intersecting in the plane spreading orthogonally to the rotation axis A, the extending directions of the X-axis and the Y-axis can be arbitrarily determined.

As illustrated in FIG. 4, the abnormality detecting device 10 includes a controller 12. The controller 12 includes an input interface 121. The input interface 121 is configured as a hardware interface for receiving the detection signal DT. In a case where the detection signal DT is an analog signal, the input interface 121 is provided with an appropriate conversion circuit including an A/D converter. This description is similarly applied to other signals described later that are to be received by the input interface 121.

The controller 12 includes a processor 122. The processor 122 is configured to detect an abnormality in the fastening state of the nut 22 based on the detection signal DT.

As illustrated in FIGS. 3 and 4, the abnormality detecting device 10 includes an indicator 13. The indicator 13 is configured to visually notify an abnormality occurring in the fastening state of the nut 22. As an example, the indicator 13 includes a light emitting element. Examples of the light emitting element include a light emitting diode for emitting light of a prescribed color. In other words, the indicator 13 is configured to provide a visual notification by emitting light.

As illustrated in FIG. 4, the controller 12 includes an output interface 123. The processor 122 is configured to output a control signal CT from the output interface 123 in a case where an abnormality is detected in the fastening state of the nut 22 and a stationary state of the wheel 21 is detected. The control signal CT is configured to cause the indicator 13 to provide the visual notification.

In other words, the output interface 123 is configured as a hardware interface for outputting the control signal CT. The control signal CT may be an analog signal or a digital signal in accordance with the specification of the indicator 13. In a case where the control signal CT is an analog signal, the output interface 123 is provided with an appropriate conversion circuit including a D/A converter. This description is similarly applied to other signals described later that are to be outputted from the output interface 123.

Although not illustrated, the abnormality detecting device 10 includes a battery for supplying power to each component including the sensor 11, the controller 12, and the indicator 13. The battery may be a primary battery or a secondary battery.

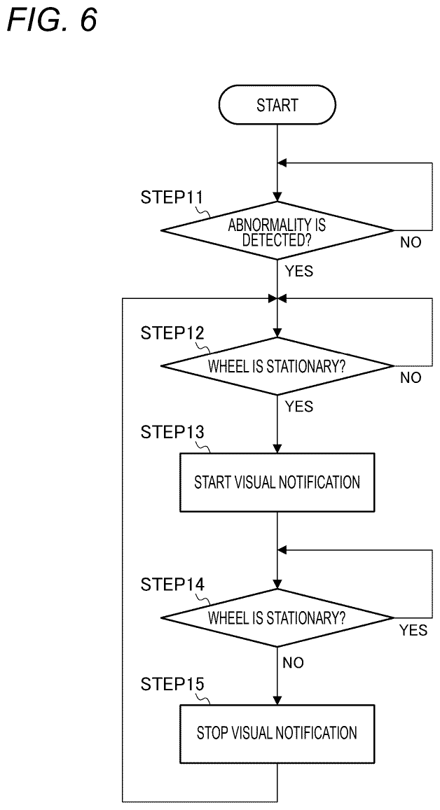

Referring to FIG. 6, a specific exemplary processing executed by the processor 122 configured as described above will be described.

First, the processor 122 determines whether an abnormality is detected in the fastening state of the nut 22 (STEP11).

As illustrated in FIG. 5, when as wheel 21 is rotated, each nut 22 is displaced along a track P about the rotation axis A. A centrifugal acceleration G corresponding to the rotation velocity of the wheel 21 acts on each nut 22. The acceleration Gx and the acceleration Gy described above correspond to an X-axis direction component and a Y-axis direction component of the centrifugal acceleration G. In other words, the vector representing the centrifugal acceleration G corresponds to a composite vector of a vector representing the acceleration Gx and a vector representing the acceleration Gy.

The processor 122 acquires the detection signal DT at prescribed time intervals, and calculates a ratio between the acceleration Gx and the acceleration Gy. As an example, it is calculated a value obtained by dividing an absolute value of the acceleration Gx with an absolute value of the acceleration Gy. As another example, a value obtained by dividing the absolute value of the acceleration Gy with the absolute value of the acceleration Gx, or a value obtained by dividing one of the acceleration Gx and the acceleration Gy with a square root value of a sum of squares of the acceleration Gx and the acceleration Gy may be calculated.

In a case where a nut 22 is loosened, as an example of the abnormality in the fastening state, the posture of the nut 22 changes. As a result, the directions of the X-axis and the Y-axis change from the initial state, as indicated by dashed lines in FIG. 5. Accordingly, a change occurs as well in the value related to the ratio described above. The processor 122 compares a value related to the ratio calculated at a certain time point with a value calculated prior to the time point to specify an amount of change. The processor 122 determines that the nut 22 is abnormally loosened (an abnormality occurs) in a case where the amount of change as specified exceeds a threshold value.

The processing is repeated until it is determined that the abnormality occurs in the fastening state of the nut 22 (NO in STEP11).

In a case where it is determined that the abnormality occurs in the fastening state of the nut 22 (YES in STEP11), the processor determines whether the wheel 21 is in the stationary state (STEP12).

Specifically, the processor 122 calculates the above-described centrifugal acceleration G based on the information indicating the acceleration Gx and the information indicating the acceleration Gy included in the detection signal DT. The centrifugal acceleration G is calculated as a square root value of a sum of squares of the acceleration Gx and the acceleration Gy. It is assumed that a magnitude of the gravitational acceleration is sufficiently small relative to the magnitude of the centrifugal acceleration.

The magnitude of the centrifugal acceleration G corresponds to the velocity of the vehicle 20. In a case where the vehicle 20 stops and the wheel 21 is brought into the stationary state, the square root value of the sum of squares calculated as described above takes 1. In a case where the magnitude of the centrifugal acceleration G as calculated is 1, the processor 122 determines that the wheel 21 is in the stationary state.

The processing is repeated until it is determined that the wheel 21 is in the stationary state (NO in STEP12).

In a case where it is determined that the wheel 21 is in the stationary state (YES in STEP12), the processor 122 outputs, from the output interface 123, the control signal CT for causing the indicator 13 to visually notify the abnormality (STEP13). The indicator 13 initiates the visual notification (light emission) based on the control signal CT. The light emitted from the indicator 13 can be recognized by an occupant through, for example, a door mirror 23 (see FIG. 1) of the vehicle 20.

Subsequently, the processor 122 again determines whether the wheel 21 is in the stationary state (STEP14). The processing is repeated until it is determined that the wheel 21 is not in the stationary state (YES in STEP14).

In a case where it is determined that the wheel 21 is not in the stationary state (NO in STEP14), the processor 122 outputs a control signal CT for causing the indicator 13 to stop the visual notification from the output interface 123 (STEP15). The indicator 13 stops the visual notification (light emission) based on the control signal CT. Thereafter, the processing returns to STEP12.

According to the configuration of the present exemplary embodiment, it is possible to improve the flexibility as for selection of how to perform the visual notification. For example, a notification with red or orange light emission is preferable because a high level of alert to the abnormality can be provided. However, in a case where such a notification is performed by the indicator 13 of the abnormality detecting device 10 attached to the nut 22 while the vehicle 20 is traveling, misunderstanding or confusion would be occurred in another traffic entity (another vehicle, a pedestrian, or the like). According to the above configuration, since the notification is performed only during the stoppage of the vehicle 20, it is possible to actively utilize such a way of notification that can provide the high level of alert to the abnormality while suppressing the possible influence on another traffic entity. Accordingly, it is possible to improve the convenience of the device for detecting the state that the wheel 21 is abnormally fixed to the vehicle 20.

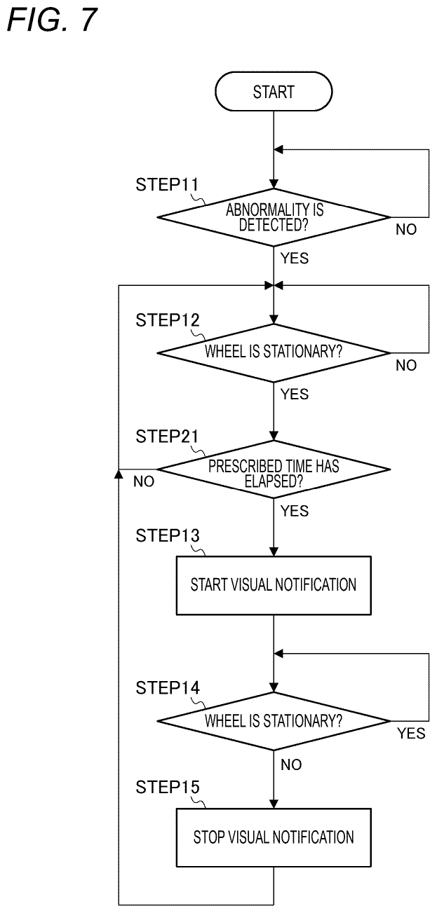

FIG. 7 illustrates another exemplary flow of processing that may be executed by the processor 122. Processing elements common to those in FIG. 6 are assigned with the same step numbers, and repetitive descriptions for those will be omitted.

In this example, as it is determined that the wheel 21 is in the stationary state (YES in STEP12), the processor 122 starts clocking, and determines whether a prescribed time period has elapsed (STEP21). The time period may be appropriately determined.

In a case where it is determined that the prescribed time period has not elapsed (NO in STEP21), the processor 122 returns the processing to STEP12. At this time, when it is determined that the wheel 21 is not in the stationary state (NO in STEP12), the clocking is stopped, and the processing is repeated until it is determined that the wheel 21 is in the stationary state. In a case where it is determined that the wheel 21 is still in the stationary state (YES in STEP12), the clocking is continued, and it is determined again whether the prescribed time period has elapsed (STEP21).

In a case where it is determined that the prescribed time period has elapsed (YES in STEP21), the processor 122 outputs, from the output interface 123, the control signal CT for causing the indicator 13 to visually notify the abnormality (STEP13). The indicator 13 initiates the visual notification (light emission) based on the control signal CT.

The notification of the abnormality is for prompting the occupant of the vehicle 20 to perform an inspection. However, in a situation that the traveling is restarted immediately after the vehicle 20 stops, the execution of the inspection cannot be expected. For example, by setting the prescribed time period as a time length in which it is possible to determine that the vehicle 20 would be continuously stopped, not only it is possible to improve the effectiveness of the notification, but also it is possible to suppress the power consumption caused by the execution of a useless notification.

As illustrated in FIG. 4, the abnormality detecting device 10 may include a transmitter 14. The transmitter 14 is configured to wirelessly transmit an abnormality signal AB for notifying the occupant of the vehicle 20 of the abnormality occurring in the fastening state of the nut 22. The abnormal signal AB is received by a receiver installed in the vehicle 20. The notification to the occupant based on the abnormality signal AB is performed by an appropriate notification device disposed in a cabin of the vehicle 20. The notification may be performed with at least one of a visual notification, an audible notification, and a haptic notification.

Specifically, as it is determined that an abnormality occurs in the fastening state of the nut 22 (YES in STEP11), the processor 122 outputs, from the output interface 123, a transmission control signal TR for causing the transmitter 14 to transmit the abnormality signal AB.

According to such a configuration, it is possible to allow the occupant of the vehicle 20 to quickly recognize the abnormality occurring in the fastening state of the nut 22. As a result, the occupant can smoothly transition to the inspection of the nut 22. In addition, since the notification based on the abnormality signal AB can be performed prior to the visual notification by the indicator 13, it is possible to enhance flexibility as for selection of how to perform the visual notification as well as selection of timing at which the visual notification is initiated.

For example, the “prescribed time period” in the processing described with reference to FIG. 7 can be selected as a time length sufficient for an occupant who stops the vehicle to move a position where the nut 22 can be visually confirmed. As a result, since it is possible to suppress the notification by the indicator 13 from being performed during a time period other than when the inspection is performed, it is possible to suppress the power consumption of the abnormality detecting device 10.

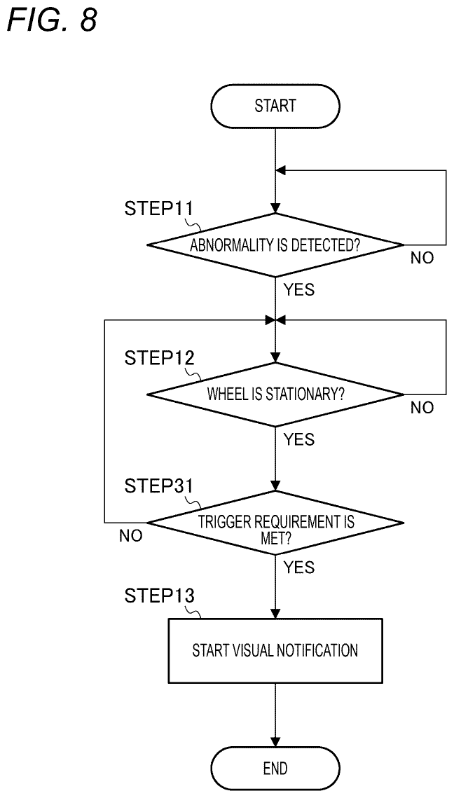

FIG. 8 illustrates another exemplary flow of processing that may be executed by the processor 122. Processing elements common to those in FIG. 6 are assigned with the same step numbers, and repetitive descriptions for those will be omitted.

In this example, as it is determined that the wheel 21 is in the stationary state (YES in STEP12), the processor 122 determines whether a prescribed trigger requirement is met (STEP31).

In a case where it is determined that the trigger requirement is not met (NO in STEP31), the processor 122 returns the processing to STEP12. In a case where it is determined that the trigger requirement is met (YES in STEP31), the processor 122 outputs the control signal CT for causing the indicator 13 to visually notify the abnormality from the output interface 123 (STEP13). The indicator 13 initiates the visual notification (light emission) based on the control signal CT.

As illustrated in FIG. 4, the abnormality detecting device 10 may include a trigger signal source 15. The trigger signal source 15 may be an actuated member such as a button capable of being actuated by an inspection worker. The trigger signal source 15 is configured to output a trigger signal TG in accordance with an operation performed by the inspection worker. The trigger signal TG may be an analog signal or a digital signal in accordance with the specification of the trigger signal source 15. The trigger signal TG is received by the input interface 121 of the controller 12. In this case, the trigger requirement described above is that the trigger signal TG is received by the input interface 121.

In this example, in response to the notification based on the abnormality signal AB, an occupant of the vehicle 20 who recognized that any of the nuts 22 has abnormality may get off the vehicle 20 and actuates the trigger signal source 15 of each nut 22. In a case where a nut 22 has abnormality in the fastening state, the indicator 13 associated with the nut 22 starts the visual notification in response to the operation with respect to the trigger signal source 15.

Also with such a configuration, since it is possible to suppress the notification by the indicator 13 from being performed during a time period other than when the inspection is performed, it is possible to suppress the power consumption of the abnormality detecting device 10.

The trigger signal source 15 may be a mobile device capable of being carried by the occupant of the vehicle 20. In this case, the mobile device is configured to transmit the trigger signal TG in response to an input of a prescribed operation. The abnormality detecting device 10 includes a receiver (not illustrated) capable of receiving the trigger signal TG. In this case as well, the trigger requirement described above is that the trigger signal TG is received by the input interface 121.

In this example, in response to the notification based on the abnormality signal AB, an occupant of the vehicle 20 who recognized that any of the nuts 22 has abnormality may get off the vehicle 20 and inputs the prescribed operation to the mobile device. In a case where a nut 22 has abnormality in the fastening state, the indicator 13 associated with the nut 22 starts the visual notification in response to the trigger signal TG transmitted from the mobile device.

According to such a configuration, since it is not necessary to provide a movable component for each abnormality detecting device 10, the structure thereof can be simplified. The wireless communication between the mobile device and the abnormality detecting device 10 may be a close-proximity wireless communication or a short-range wireless communication. In the latter case, since the trigger signal TG can be collectively transmitted to each abnormality detecting device 10, it is possible to improve the efficiency of the inspection work.

The trigger requirement described above may be that the abnormality detecting device 10 is removed from the nut 22. Specifically, the processor 122 determines that the abnormality detecting device 10 is removed from the nut 22 in a case where the information indicating the acceleration Gx and the information indicating the acceleration Gy included in the detection signal DT outputted from the sensor 11 have specific values.

The values are so determined as to be values that would not be taken under a condition that the abnormality detecting device 10 is attached to the nut 22. For example, the values of the acceleration Gx and the acceleration Gy when the abnormality detecting device 10 is removed from the nut 22 and the indicator 13 is directed upward or downward may be employed.

In this example, in response to the notification based on the abnormality signal AB, an occupant of the vehicle 20 who recognized that any of the nuts 22 has abnormality may get off the vehicle 20, remove the abnormality detecting device 10 from the nut 22, and direct the indicator 13 upward or downward. In a case where the abnormality detecting device 10 is removed from a nut 22 has abnormality in the fastening state, the indicator 13 associated with the abnormality detecting device 10 starts the visual notification in response to the operation with respect to the trigger signal source 15.

According to such a configuration, it is possible to cause the indicator 10 to start the notification using the detection signal DT outputted from the sensor 11. Since it is not necessary to provide the trigger signal source 15 and the receiver described above, the structure of the abnormality detecting device 10 can be simplified.

Each configuration described above is merely illustrative for facilitating understanding of the presently disclosed subject matter. Each of the above exemplary configurations can be appropriately modified or combined with another exemplary configuration within the teaching of the presently disclosed subject matter.

In the above exemplary embodiment, the acceleration sensor is used as the sensor 11. However, a magnetic sensor may be used as the sensor 11. In this case, a magnet is attached to the nut 22, whereas the sensor 11 is disposed in the abnormality detecting device 10 at a position capable of detecting the magnetism generated from the magnet. The sensor 11 outputs a detection signal DT including information corresponding to the detected magnetism.

In a case where the magnetic sensor is used as the sensor 11, as illustrated in FIG. 4, the input interface 121 of the controller 12 is configured to receive, from the vehicle velocity sensor 16, a velocity signal VL containing information corresponding to the velocity of the vehicle 20. The vehicle velocity sensor 16 may be implemented by an acceleration sensor provided in the abnormality detecting device 10, or may be implemented by a sensor disposed at an appropriate position in the vehicle 20. In the latter case, the sensor wirelessly transmits the velocity signal VL. The abnormality detecting device 10 includes a receiver (not illustrated) capable of receiving the velocity signal VL.

As the nut 22 is loosened, the magnetism detected by the sensor 11 changes. In a case where the magnitude of the change indicated by the detection signal DT exceeds a threshold value, the processor 122 of the controller 12 determines that an abnormality occurs in the fastening state of the nut 22. Based on the determination, the processor 122 outputs, from the output interface 123, the transmission control signal TR for causing the transmitter 14 to transmit the abnormal signal AB.

In addition to or in place of the transmission of the abnormality signal AB, the processor 122 outputs, from the output interface 123, the control signal CT for causing the indicator 13 to start the visual notification in a case where it is determined that there is an abnormality in the fastening state of the nut 22 and that the wheel 21 is in the stationary state based on the velocity signal VL.

As described with reference to FIG. 7, the visual notification of the indicator 13 may be initiated after the elapse of a prescribed time period from the time when the above determination is made.

In a case where the magnetic sensor is used as the sensor 11, the trigger requirement described with reference to FIG. 8 may be that the abnormality detecting device 10 is removed from the nut 22. Specifically, the processor 122 determines that the abnormality detecting device 10 is removed from the nut 22 in a case where the strength of the detected magnetism indicated by the detection signal DT outputted from the sensor 11 is less than a threshold value.

In this example, in response to the notification based on the abnormality signal AB, an occupant of the vehicle 20 who recognized that any of the nuts 22 has abnormality may get off the vehicle 20, and remove the abnormality detecting device 10 from the nut 22. In a case where the abnormality detecting device 10 is removed from a nut 22 has abnormality in the fastening state, the indicator 13 associated with the abnormality detecting device 10 starts the visual notification in response to the operation with respect to the trigger signal source 15.

In the example of the above embodiment, the abnormality detecting device 10 is attached to the nut 22 fastened to the bolt for fixing the wheel 21 to the vehicle 20. However, in a configuration wherein the wheel 21 is fixed by fastening a bolt to an internal screw provided on the vehicle 20, the abnormality detecting device 10 can be attached to the bolt.

The present application is based on Japanese Patent Application No. 2023-057868 filed on Mar. 31, 2023, the entire contents of which are incorporated herein by reference.

1. An abnormality detecting device adapted to be attached to a fastening member for fixing a wheel to a vehicle, comprising:
a sensor configured to output a detection signal corresponding to a fastening state of the fastening member;
a processor configured to detect an abnormality in the fastening state based on the detection signal; and
an indicator configured to perform a visual notification of the abnormality,
wherein the processor is configured to cause the indicator to start the visual notification in a case where the abnormality is detected under a condition that a stationary state of the wheel is detected.

2. The abnormality detecting device according to claim 1,
wherein the processor is configured to cause the indicator to start the visual notification after elapse of a prescribed time period from when the stationary state of the wheel is detected.

3. The abnormality detecting device according to claim 1, further comprising:
a transmitter configured to transmit an abnormality signal for notifying an occupant of the vehicle of the abnormality.

4. The abnormality detecting device according to claim 3,
wherein the processor is configured to cause the indicator to start the visual notification in response to a reception of a prescribed signal that is made after the stationary state of the wheel is detected.

5. The abnormality detecting device according to claim 3,
wherein the processor is configured to cause the indicator to start the visual notification after a detection that the abnormality detecting device is removed from the fastening member.

6. The abnormality detecting device according to claim 1,
wherein the sensor is an acceleration sensor.
